(19) United States
(12) Patent Application Publication
(10) Pub. No.: US 2022/0194580 A1
(43) Pub. Date: Jun. 23, 2022

(54) MONITORING TOOL, SYSTEM AND METHOD FOR EARTH WORKING EQUIPMENT AND OPERATIONS

(71) Applicant: ESCO GROUP LLC, Portland, OR (US)

(72) Inventor: NOAH D. COWGILL, PORTLAND, OR (US)

(73) Assignee: ESCO GROUP LLC, Portland, OR (US)

(21) Appl. No.: 17/611,068

(22) PCT Filed: May 13, 2020
(86) PCT No.: PCT/US2020/032617

§ 371 Date: Nov. 12, 2021

Related U.S. Application Data
(60) Provisional application No. 62/847,842, filed on May 14, 2019.

(51) Int. Cl. B64C 39/02; E02F 9/26; E02F 3/28; B64F 1/36; G07C 5/08

(52) U.S. Cl. CPC B64C 39/024; E02F 9/26; E02F 3/28; B64C 2201/12; G07C 5/0808; E02F 9/261; G07C 2205/02; B64F 1/364

(57) ABSTRACT

A system and monitoring tool for monitoring at least one characteristic of an earth working operation. The monitoring tool includes an unmanned vehicle and a tether connecting the unmanned vehicle to home device. The tether may provide a secure connection for transmission of information and/or power to the unmanned vehicle.

### RELATED APPLICATION

This application claims the benefit of priority from U.S. Provisional Patent Application No. 62/847,842, filed May 14, 2019, the entirety of which is incorporated by reference.

### FIELD OF THE DISCLOSURE

The present disclosure pertains to a monitoring tool, system and process for monitoring earth working operations.

### BACKGROUND OF THE DISCLOSURE

Multiple configurations of excavating machines and buckets are known and variations in both exist. FIGS. 1A-1B illustrate two examples of earth working equipment. FIG. 1A illustrates an excavator equipped with a boom 2, a stick 20 and a bucket 3 for gathering earthen material 24. FIG. 1B illustrates a cable shovel equipped with a bucket 3A with a hinged door 10A to release earthen material 24A. Referring to FIG. 2, the bucket 3 includes a shell 4 defining a cavity 16 for gathering material during the digging operation. Shell 4 includes a rear wall 12 with supports 8 to attach the bucket 3 to earth working equipment 1, and a pair of opposing sidewalls 14 located to each side of rear wall 12. The bucket 3 has a lip 5 that defines a digging edge 34 of the bucket 3. Teeth 7 and/or shrouds 9 are often secured to the digging edge 34 to protect the edge 34, break up the ground ahead of the lip 5, and/or gather material into the bucket 3. Multiple teeth 7 and shrouds 9, such as disclosed in U.S. Pat. No. 9,222,243 may be attached to lip 5 of bucket 3.

With reference to FIGS. 3-4, each tooth 7 includes an adapter 11 welded to lip 5, an intermediate adapter 13 mounted on adapter 11, and a point (also called a tip) 15 mounted on intermediate adapter 13. Point 15 includes a rearwardly-opening cavity 18 to receive nose 17 of intermediate adapter 13, and a front end 19 to penetrate the ground. Intermediate adapter 13 includes a rearwardly-opening cavity 22 to receive a nose 23 of adapter 11. Locks 21 are used to secure point 15 to intermediate adapter 13, and intermediate adapter 13 to adapter 11 (FIG. 4). Other tooth arrangements are possible, such as disclosed in U.S. Pat. No. 7,882,649.

In this example, the point 15 will generally wear out and need to be replaced a number of times. The intermediate adapter 13 may be referred to as a base for this wear part. However, the intermediate adapter 13 may also be referred to as a wear part. Likewise, while the adapter 11 is a base for the intermediate adapter 13, adapter 11 may also be considered a wear part that can be replaced when worn. When such wear parts reach a minimum recommended wear profile (e.g., the wear member is considered fully worn), the product is replaced so that production does not decrease and the base, upon which the wear part mounts, does not experience unnecessary wear.

During use, such ground-engaging products can encounter heavy loading and highly abrasive conditions. These conditions can cause the products to wear or become separated from the earth working equipment. For example, as a bucket engages the ground, a wear part such as a point or intermediate adapter may become separated from the digging edge. The operators of the earth working equipment may not always be able to see when such products have separated from the bucket. Continuing to operate the earth working equipment with missing ground-engaging products (such as points) can lead to a decrease in production and/or excessive wear on the lip, bucket walls or other components on the earth working equipment. It is also known that a lost wear part in a mining environment may cause damage to downstream equipment (e.g., crushers), which may, in turn, for example, lead to unscheduled downtime of the equipment and loss of production. If a wear part becomes caught in a crusher, the wear part may be ejected and cause a hazard to workers or it may be jammed and require an operator to dislodge the part, which at times may be a difficult, time-consuming and/or hazardous process. Excessive wearing of the teeth and/or shrouds can also result in decreased equipment efficiency and production, greater costs in fuel consumption, etc.

There are existing systems that have been used to monitor wear parts in an effort to determine when a wear part needs replacement and/or has been lost with varying degrees of success. For example, systems sold by Motion Metrics use an optical camera mounted on the excavating equipment to determine the amount of wear in the wear parts and when wear parts are lost. Current systems for monitoring of ground-engaging products have not, however, consistently provided satisfactory results on account of the environment, limited viewing capabilities, etc.

### SUMMARY OF THE DISCLOSURE

The present disclosure pertains to a monitoring tool, system and/or method for monitoring earth working equipment, wear parts, operations and/or the earthen material such as found in mining and construction.

In one example, a monitoring tool includes an unmanned vehicle and a tether. The vehicle includes an electronic device to monitor at least one characteristic pertaining to an earth working operation, and to transmit information pertaining to the at least one characteristic. The tether connects the unmanned vehicle to a home device.

In another example, a monitoring tool includes a home device, an unmanned vehicle having an electronic device to monitor at least one characteristic pertaining to an earth working operation and to transmit information pertaining to the at least one characteristic, and a tether connecting the unmanned vehicle to the home device.

In another example, a monitoring system includes at least one earth working equipment and a monitoring tool. The monitoring tool includes a home device, an unmanned vehicle having an electronic device to monitor at least one characteristic pertaining to an earth working operation and to transmit information pertaining to the at least one characteristic, and a tether connecting the unmanned vehicle to the home device.

In any of the above examples, the tether can optionally provide power and/or data transmission. The unmanned vehicle may be remotely controlled or autonomous or some combination thereof. The unmanned vehicle can be an aerial and/or land vehicle.

In another example, the unmanned vehicle is connected to a home device. The home device may be a stand-alone device, secured to a transport vehicle, an earth working equipment and/or other structure, or be the vehicle, equipment or the like. The unmanned vehicle is connected to the home device by a tether to secure, power and/or transmit data to and/or from the unmanned vehicle. The home device can include a power source to provide power to the monitoring tool. The home device may include a transceiver to receive and send data to and/or from a remote device. The home device may also include a processor to make determinations based on the information received from the monitoring tool.

The various above-noted implementations and examples are usable together or independently. To gain an improved understanding of the advantages and features of the disclosure, reference may be made to the following descriptive matter and accompanying figures that describe and illustrate various configurations and concepts related to the disclosure.

### BRIEF DESCRIPTION OF THE DRAWINGS

FIG. 1A is a side view of an earth working machine.

FIG. 1B is a side view of another earth working machine.

FIG. 2 is a perspective view of a bucket with teeth and shrouds.

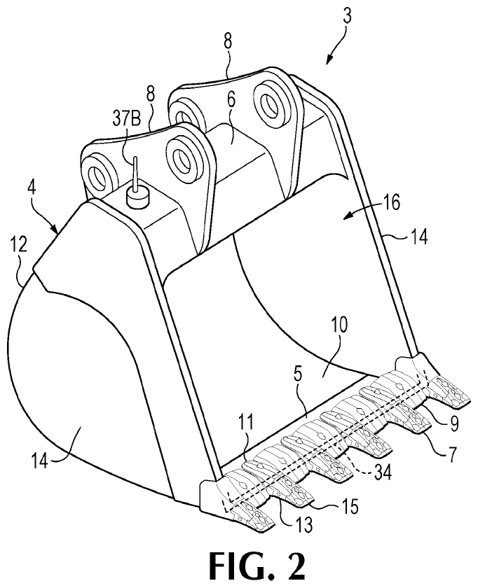

FIG. 3 is a perspective view of one of the teeth shown in FIG. 2.

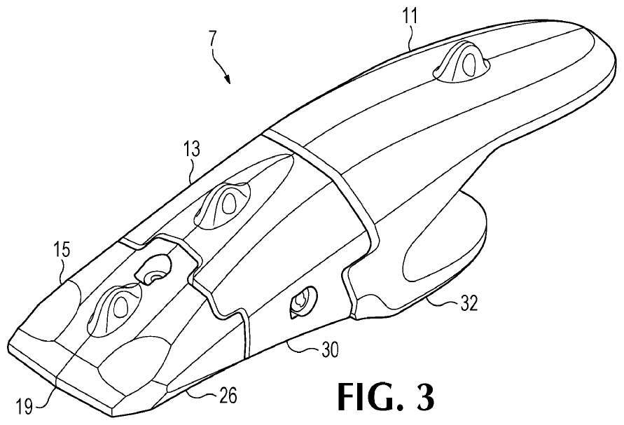

FIG. 4 is an exploded perspective view of one of the teeth shown in FIG. 3.

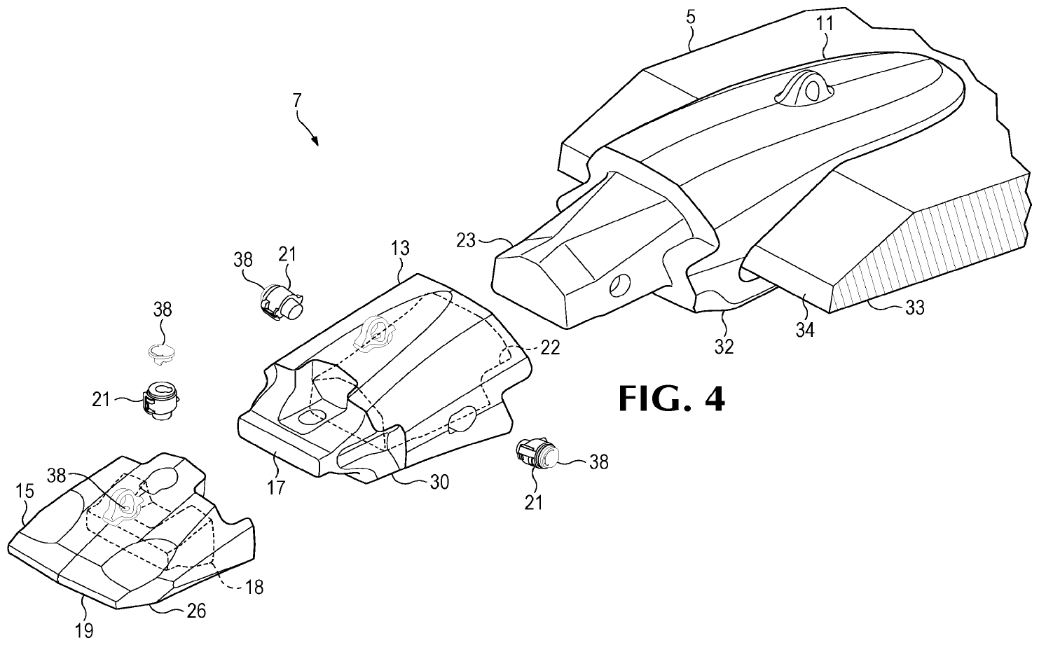

FIG. 5 illustrates a first example of a monitoring system in accordance with the present disclosure.

FIG. 6 illustrates a second example of a monitoring system in accordance with the present disclosure.

FIG. 7 illustrates a third example of a monitoring system in accordance with the present disclosure.

FIG. 8 illustrates a fourth example of a monitoring system in accordance with the present disclosure.

FIG. 9 is a front view of an example mobile handheld device with a human machine interface (HMI) to be used with a monitoring system in accordance with the present disclosure.

FIG. 10 illustrates a fifth example of a monitoring system in accordance with the present disclosure.

### DETAILED DESCRIPTION OF PREFERRED EMBODIMENTS

The present disclosure pertains to a monitoring tool, system and/or process for monitoring at least one characteristic of an earth working operation.

In one embodiment, a monitoring tool includes a tethered vehicle having a sensor. The tether can provide power and/or data transmission for the monitoring tool. The tether can also improve the safety of the monitoring tool. The monitoring tool can be used to monitor at least one characteristic of one or more earth working operation including, for example, the monitoring of earth working equipment (including its usage, performance, components, wear parts, etc.) and/or the earthen material associated with the earth working operation. The monitoring tool, system and/or process can include any or all the features, capabilities, embodiments and/or operations as disclosed for the monitoring tools, systems and/or processes in U.S. Publication No. 2016/0237640 filed Feb. 12, 2016, which is herein incorporated by reference in its entirety.

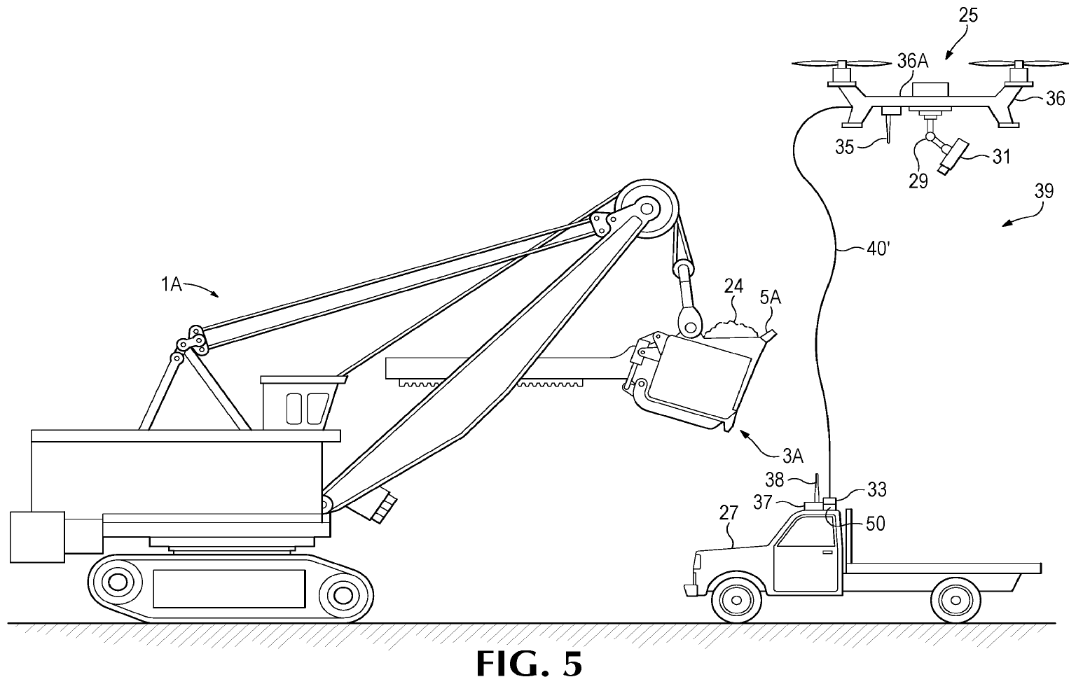

With reference to FIG. 5, a monitoring system 39 is illustrated according to one example. The monitoring system 39, in this example, includes an earth working equipment 1A in the form of a cable shovel having a ground engaging product 3A in the form of dipper with ground-engaging wear parts 5A in the form of teeth and shrouds, and a monitoring tool 25. The monitoring tool 25 can monitor at least one characteristic of an earth working operation, examples of which can include the condition, usage and/or performance of the earth working equipment, its components (e.g., its boom, stick, pulleys, etc.), its associated wear parts (e.g., teeth, shrouds, track pads, etc.), other related equipment (e.g., haul trucks) and/or the earthen material before, during and/or after it is gathered in the dipper 3A.

The monitoring tool 25 may include a unmanned vehicle 36, a sensor or electronic device 31 supported by the unmanned vehicle, and a tether 40 connecting the unmanned vehicle to a home device 33. In the illustrated example, the unmanned vehicle 36 is an unmanned aerial vehicle (UAV) 36A though land-based vehicles can also be used. The tethered UAV 36A may be in the form of, e.g., a drone, helicopter, blimp, airplane, or other aerial vehicle, and include at least one sensor 31. As one example, the electronic device 31 may be a surface characterization device, e.g., a camera or other device that creates, e.g., a two- or three-dimensional representation (e.g. point cloud) or other representation of at least a portion of the equipment 1A, the components thereof, wear parts 5A, gathered material, earthen material to be excavated, associated equipment, etc. Using a tethered UAV 36A for monitoring equipment, usage, wear parts, etc. has certain advantages, in that, the aerial monitoring tool 25 can, e.g., provide unique vantage points and/or to take readings at virtually any point in the operation without inhibiting the operation, requiring the equipment or other monitored item(s) to be in a particular location and/or orientation, and/or endangering personnel. The unmanned vehicle 36 permits a sensor 31 to closely approach the area(s) of interest (such as components of the equipment, wear parts secured to the equipment, an earthen bank to be excavated, etc.) for secure and reliable gathering of information. The tethered UAV 36A is connected to the home device 33 via tether 40.

The use of a tether 40 can improve safety of the monitoring operation such that the UAV 36A can only fly in a limited radius of space from the home device 33 as defined by the length of the tether. For example, the tether 40 limits the potential fly space of the UAV 36A to provide a level of safety against the UAV 36A flying into unintended space (e.g., into the earth working equipment, other sectors of the mine, etc.). The use of a tether 40 secured to the unmanned vehicle can also reduce the risk of theft. The tether 40 can be composed of a wide variety of materials so long as they provide sufficient strength, flexibility and/or durability for the anticipated operations. The tether is preferably lightweight, flexible, and thin to minimize the drag and/or interference that can result on account of weather conditions (e.g., high winds) reacting on the tether. This allows the tethered unmanned vehicle 36 to function in more hostile environments. The tether 40 may have a winch system to easily extract and retract the unmanned vehicle 36. The winch system can be biased to automatically eliminate unneeded lengths of the tether from being exposed and catching or becoming tangled on nearby things. The winch system can also improve safety by providing an adjustable tether length to suit different needs and, thereby an adjustable (e.g., reduced) flying space from the home device 33; this can reduce the risk of potential user error and crashes because the tethered drone has a limited spatial radius or area it can roam.

In another example, the tether 40 may include a conductive wire to power the unmanned vehicle 36, sensor and/or other components on the vehicle. The tether 40 may pass power to the tethered unmanned vehicle 36 from a power source or supply 50 associated with the home device 33 to extend the time the UAV 36A can be airborne and/or increase the number, kind or capabilities of the sensor(s) or other components on the unmanned vehicle. The power supply 50 could, e.g., include one or more battery, generator, or other electrical power source and/or a connection from the home device 33 to another power source (e.g., the earth working equipment, transport vehicle, electrical outlet, etc.). As examples only, the power supply 50 may, e.g., convert alternating current (AC) electricity into direct current (DC) electricity, and the tethered unmanned vehicle 36 may include DC-DC converters to supply lower voltage power to the sensor 31 and other components. The power through the tether 40, in certain embodiments, can allow for virtually unlimited flight or work times rather than being limited by the battery capacity of the drone. The enhanced power can also be useful in running one or more sensors carried by the tethered unmanned vehicle 36 and/or powering other components such as processors, lights, etc. The sensor 31 and/or tethered UAV 36A could include battery power instead of or in addition to power through the tether, which can, e.g., allow for a fail-safe operation, operation when the tether does not transmit power and/or if a power supply is not available at a particular site.

In another example, the tether 40 may include a wire, optical fiber or other communication transmission conduit to allow the tethered unmanned vehicle 36 to pass signals to and/or from the home device 33. Such signals may include such things as sensor data, software, and/or operating instructions for the tethered unmanned vehicle 36. The tether 40 may exist as a standalone network (e.g. just the home device 33 and the tethered unmanned vehicle 36) or may be a part of a larger network (e.g. network 142). The tether 40 may optionally be encrypted for use with the home device 33 to allow for a more secure transfer of information. In embodiments where data is communicated through the tether 40, the data transmission can be faster, more reliable and/or better secured against unauthorized reception as compared to a wireless signal. The unmanned vehicle 36 may optionally include a wireless transmitter 35 as a supplement or backup to transmitting through the tether 40 or when used with a tether lacking data transmission and/or when a receiver for the tether is not available on site.

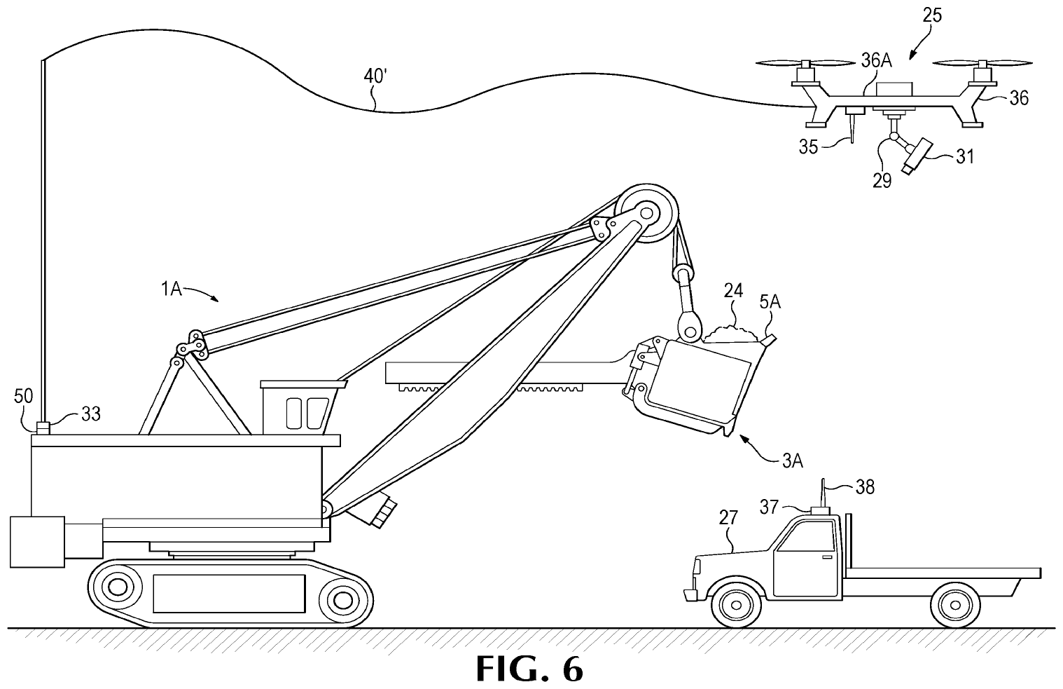

The home device 33 can be carried by and/or secured to, or be one of, a service truck or other vehicle 27 (FIG. 5), earth working equipment 1 (FIG. 6), or other structure, equipment or device on the worksite. The home device 33 can be a discrete device that is carried by or connected (or connectable) to a vehicle, equipment or other structure, and/or which could be a standalone device that can be placed at a suitable location on the worksite. For example, the home device 33, tether 40, and unmanned vehicle 36 could be a discrete monitoring tool 25 that is carried by a service truck to one or more locations on a mine site or other worksite. As another example, a monitoring tool 25 could be transported by a service truck and left at a particular location at a mine site or other worksite. As another example, one or more monitoring tool 25 could be coupled to and/or carried by equipment at a worksite such as excavating equipment, haul trucks, crushers and/or other mineral processing equipment, conveying equipment, chutes, etc. In another example, the unmanned vehicle 36 could be flown to the location for monitoring (e.g., earth working equipment) without the need for a separate transport vehicle 27 and there connected to a tether 40 secured to a home device 33; the unmanned vehicle 36 could in some cases carry the tether 40 with it for securing to a home device 33. As another example, the home device 33 could be an autonomously or remotely controlled vehicle. The home device 33 operates as a base for the unmanned vehicle 36 and is optionally capable of acting as a power source, transmitter/receiver, base/hub, anchor, landing spot, garage, vehicle, connector, etc. The home device 33 could also include a processor 199 for processing data received from the tethered unmanned vehicle 36 by means of the tether 40 or other means.

There are a number of off-the-shelf UAVs that could be used or modified for use as the unmanned vehicle of the present disclosure; the unmanned vehicle may also be custom built. For example, the tethered UAV 36A may require an operator to maneuver the tethered UAV 36A by means of, e.g., a joystick. The UAV 36A may be autonomous or a combination of control by operator and by programming for flight, takeoff, and/or landing. In addition, the tethered UAV 36A may automatically hover in place above the earth working equipment 1A; the hover location could be determined by an operator, automatically through use of beacon 37A, sensor 31 and/or other means, and/or by other suitable operations. In another example, the monitoring tool may by such things as programming, sensors, beacons, etc. can maneuver to continuously, periodically, cyclically and/or in other ways monitor at least one characteristic of an earth working operation such as monitoring usage, condition and/or performance of an earth working equipment, its components, wear parts, etc. and/or the earthen material. In another example, the tethered UAV 36A may not require an operator for takeoff or landing and may fly a set pattern before landing. The tethered UAV 36A may coordinate and/or be controlled so as not to land in the same place or location as where the tethered UAV 36A took off.

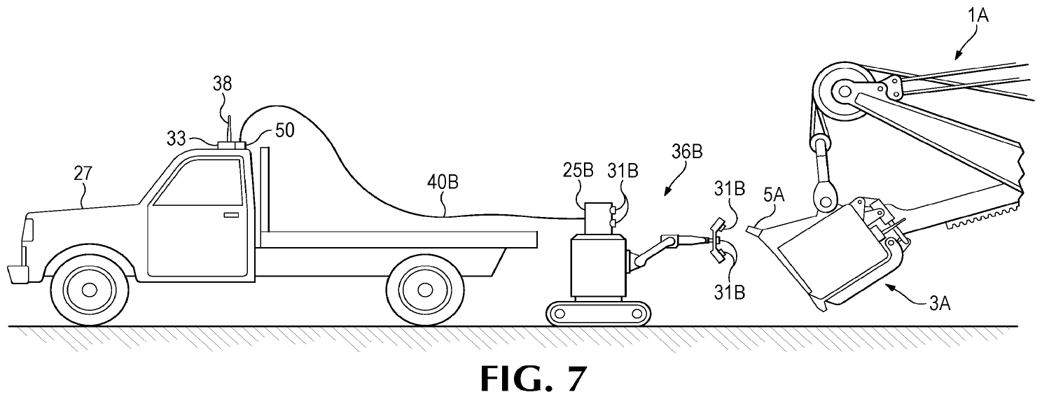

Referring to FIG. 7, the monitoring tool 25B may include a ground-based unmanned vehicle 36B, such as a tethered ground-based robot for maneuvering at least one electronic device or sensor 31B. The benefits discussed herein regarding aerial unmanned vehicles (e.g., concerning safety, power supply and communication transmission) would also apply to ground-based unmanned vehicles 36B. Also, the variations discussed above for aerial unmanned vehicles would apply to ground-based unmanned vehicles with the understanding that references to flying space and the like would be replaced by driving space and the like. In the illustrated example, a transport vehicle 27 carries the monitoring tool 25B for initial transportation to a desired location, at which point it can, optionally, be unloaded for operation (as in FIG. 7). It could alternatively stay on the transport vehicle for certain operations. In the illustrated embodiment, the ground-based robot 36B is connected to a home device 33 secured to transport vehicle 27. The ground-based unmanned vehicle 36B is capable of maneuvering an electronic device 31B so that it can monitor at least one characteristic of an earth working operation, e.g., the products 5A on bucket 3A. Alternatively, the ground-based unmanned vehicle 36B may be able to transport itself without a transport vehicle 27. The ground-based unmanned vehicle could include many variations such as different mobile arrangements (e.g., wheels, tracks, etc.), various sizes to suit the need(s) (e.g., small enough to run on existing equipment, large enough to view certain equipment and/or parts, etc.), being self-powered or powered by other vehicles or equipment, include one or more sensors, transmitters, processors, etc. As with aerial monitoring tools, the tether 40B can provide a power source and/or transmission of communications to the unmanned vehicle 36B.

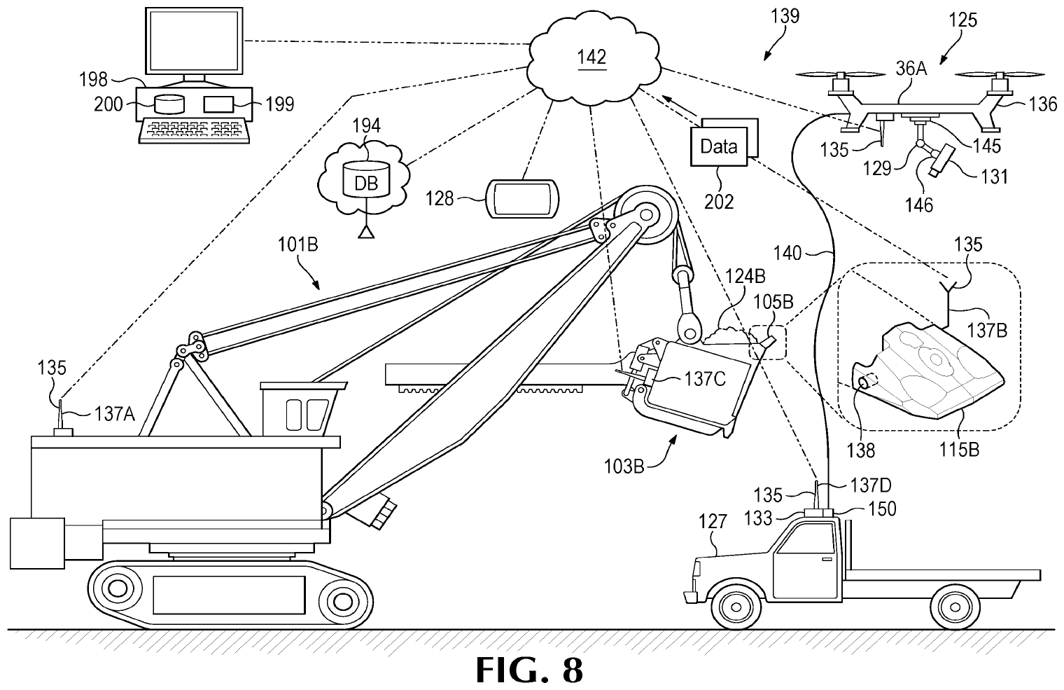

With reference to FIG. 8, a monitoring system 139 is illustrated according to one example of the disclosure. The system 139 may include an earth working equipment 101B having a ground engaging product 103B, a communication network 142, a monitoring tool 125, a transport vehicle 127, a processor 199, a database 194, and/or a handheld device 128; other alternatives and/or variations are possible. The earth working equipment 101B includes a bucket 103B having a lip 105B and carrying a load 124B. Teeth and/or other ground-engaging tools (GET) are secured to the lip; a tip 115B is illustrated in FIG. 8 as an example wear part. The tip 115B may optionally include a sensor 138 and antenna 135 such as disclosed in U.S. Pat. No. 10,011,974, which is incorporated herein by reference in its entirety. The bucket 103B, equipment 101B, GET 115B, transport vehicle 127 and/or unmanned vehicle 136 may each optionally include an antenna 135, a beacon 137A-D, and/or some combination for communicating information, providing location information, etc. As one example, the beacons could be used by the monitoring tool 25 to identify the location, position and/or orientation of equipment and the like for traveling to and/or positioning the unmanned vehicle 136 and/or sensor 131 for monitoring, and/or as a system for avoiding inadvertent crashes with existing (whether stationary or moving) equipment and the like. As one example, the home device 33 could also contain a sensor package independent of that on the unmanned vehicle 36. If the heading (compass), position, or directional acceleration of the host equipment is known to the unmanned vehicle 36 via the home device 33 mounted on it, movement of the unmanned vehicle 26 or the “aim” of its onboard sensor package can be coordinated with that of the host equipment.

The earth working equipment 101B, the transport vehicle 127, the monitoring tool 125, the ground engaging products 115B (e.g. bucket and wear members), the processor, and/or the handheld device 128 (or other HMI) may each be in communication through the communication network 142 or a standalone network between the various devices. As examples, the communication network 142 could include intranets, internets, the Internet, local area networks, wide area networks (WAN), mining site network, wireless networks (e.g. WAP), secured custom connection, wired networks, virtual networks, software defined networks, data center buses and backplanes, or any other type of network, combination of network, or variation thereof. Communication network 142 is representative of any network or collection of networks (physical or virtual) and may include various elements, such as switches, routers, fiber, wiring, wireless, and cabling to connect the various elements of the system 139. Communication between system 139 components and other computing systems, may occur over a communication network 142, tether 140, or other networks in accordance with various communication protocols, combinations of protocols, or variations thereof. It should be appreciated that the network 142 is merely exemplary of a number of possible configurations according to embodiments of the present technology. In other examples, the various components of system 139 may be co-located or may be distributed geographically.

The monitoring system 139 may include a processor 199 (with, e.g., non-transient memory 200, etc.) having computer instructions, programs, software, firmware, and the like written thereon; all such devices will be referred to herein as processors. In the illustrated example (FIG. 8), the processor 199 is remote from the monitoring tool 125 (e.g., in an office or other remote location). Nevertheless, one or more processor can be provided with the monitoring tool 125 (unmanned vehicle 136 and/or home device 133), the earth working equipment 101B, handheld device(s) 128, devices 137A-D, and/or other remote locations. The processor 199 may be provided with data from the one or more sensor 131, other sensors (such as in the GET), a handheld device 128, cloud database 194, other data sources, and/or other remote devices, etc. to provide information and analysis. The term processor 199 as used herein could include one or more processors for the system which are operated separately and/or concurrently. In one implementation, the processor 199 may optionally include the Engine Controller unit (ECU) of the earth working equipment 101B. The ECU 199 may provide or receive information from the processor 199 and/or directly to or from sensor(s) 131. The ECU 199 may provide data pertaining to, but not limited to, engine torque, fuel consumption, atmospheric temperature, engine temperature and the like. The ECU 199 data may be coupled with sensor data, and/or data from other sources, and processed by the processor 199 to provide various outputs. In one example, the processor 199 may simply facilitate communication between the monitoring tool 125 and various system components, through the network 142 and/or tether 140 by means of the communication device 135. Each of the system components may include individual processors 199 or a single processor 199 (distributed or otherwise) may control each of the various components of the system 139. In one example, the various components of the computer system 198 may be co-located, virtually, and/or may be distributed geographically. As those skilled in the art will appreciate, other exemplary computer systems 198 according to embodiments of the technology may include different components than those illustrated and described herein.

The monitoring tool 125 and/or monitoring system 139 could be used to monitor various characteristics of an earth working operation involving, for example, equipment, products, usage, performance, earthen material, etc. As examples, the monitoring tool 125 may monitor (and/or a processor(s) make determinations regarding) the condition, usage, and/or performance of earth working equipment such as excavators, haul trucks, dredging equipment, conveying equipment, chutes, crushers, mineral processing equipment, etc. and/or portions of the equipment such as lips, buckets, mold boards, sticks, booms, chassis, motive systems, truck trays, hoppers, and other components. The monitoring tool 125 and/or system 139 may, for example, monitor (and/or make determinations regarding) the presence, condition, usage and/or presence of wear parts associated with earth working equipment such as points 15, intermediate adapters 13, adapters 11, noses 15 of a cast lip, shrouds 9, runners, picks, track shoes, blades, corner shoes, hammers, and/or other wear parts. The monitoring tool 125 and/or system 139 may, for example, monitor (and/or make determinations regarding) usage and/or performance of the equipment such as the loads within the bucket, truck tray, hopper, etc., the speed of certain operations such as digging cycles, loading times, conveying times, throughput of mineral processing equipment, etc., the number of digging cycles, etc. The monitoring tool 125 and/or system 139 may, for example, monitor (and/or make determinations regarding) the earthen material such as ore concentration, fragmentation, bank angles, digging paths, etc. before, during and/or after being gathered, processed, etc. by the earth working equipment. The monitoring tool and/or system may also, for example, monitor other characteristics of an earth working operation such as part identification, operational limits, equipment faults, equipment proximity violations, locate system sensors, reading gauges and other operations within a mine site or other worksite where safety, efficacy and/or efficiency can be improved through the use of a tethered unmanned vehicle with a sensor.

In another example, a monitoring tool 125 can be used to generate data usable to map a mine site or other earth working site to estimate characteristics of the ground-engaging products on earth working equipment used at the site. For example, the gathered data could be used to generate contour-style mapping of wear rates for ground-engaging products to better determine such things as product replacement schedules, costs, etc. In one example, the data gathered by monitoring tool 125 could be combined with other data such as mine geology, GPS data, fragmentation, etc. to make such determinations. The data could be used to map other characteristics or process the site data in ways other than mapping to generate similar information. As other examples, the system can be used to determine such things as timetables for excavating certain material, replacement schedules for products, performance of an operator, etc.

The monitoring tool 125 and/or monitoring system 139 can monitor and/or determine one or more characteristics that can include information related to earth working equipment (including components, wear parts, etc.), operational limits, locating system sensors, usage, performance, condition and the like. Information related to operational limits may include such things as overfilling equipment, overstressing equipment, etc. Information related to equipment faults may include predetermined values set for maximum wear (e.g. wear profiles for specific ground engaging products). Information related to locating system sensors may include locating system sensors, such as beacons, wear sensors, blast monitoring sensors, road condition sensors, material monitoring sensors, flow monitoring sensors, fill sensors, location sensors, and the like. Information related to part identification can include such things as product type, product number, customer number, brand name, trademark, bill of material, maintenance instructions, use instructions, etc. Information related to usage can include such things as the type of earth working equipment associated with the product, number of digging cycles, average time of digging cycles, location of the product on the equipment, etc. Information related to condition of the product can include such things as wear, damage, temperature, pressure, etc. Information related to performance can include such things as the rate of digging, tons moved per each increment of wear, fill rates, throughput over a period of time, etc. As examples, throughput could include such things as how much material is gathered by a bucket over a period time, how much material is loaded into a haul truck body over time (which could optionally include measuring the loss of material in transfer), how much material is passed through a crusher or other mineral processing equipment over a period of time, how much material is passed through a chute or on a conveyer over time, and the like. As another example, the tethered UAV may spot a first piece of earth moving equipment in preparation for an operation with a second piece of earth moving equipment. For example, a haulage truck in preparation for loading by shovel. Information relating to performance, such as a time for preparation for loading may be measured. This information could also be used to coordinate the tethered UAV 136A into a specific position for better viewing. Using a monitoring tool 125 and especially an airborne unmanned vehicle 136 such as a tethered UAV 136A can be advantageous by permitting a coordinated and efficient monitoring of products on more than one earth working equipment, such as concurrently monitoring, e.g., characteristics such as the earthen bank, the condition and/or loading of a bucket, the presence and/or condition of wear parts on the bucket, the loading and/or condition of a truck body, etc.

The monitoring tool 125 can include a wide variety of sensors. As one example, the electronic device 131 may generate a two or three-dimensional point cloud representing an outer surface of at least part of a product being monitored. However, various other electronic devices (e.g., cameras, LiDAR, etc.) could be used, and various other ways to assess the equipment and/or products (e.g., optical recognition) could be used. For example, the three-dimensional representation may be generated from more than one two-dimensional optical image captured by a camera 131. Examples of numerous photogrammetry devices, digital cameras, and/or digital single lens reflex (DSLR) cameras could be used to photogrammetrically generate a three dimensional or other representations of the monitored product, load, etc. The sensor may operate continuously, at set times or event-based (e.g., upon receiving a trigger or issuance of the alert). The information gathered by monitoring tool 125 can be provided to the home device 133 and/or a remote device, for processing or use, continuously, periodically, on demand, or in batches. Irrespective of the delivery mode, the system can be operated to provide historical and/or real-time data and/or assessment.

The monitoring tool 125 can include multiple sensors. In one example, monitoring tool 125 may include multiple surface characterization devices 131 that collect different kinds of information. As an example, the monitoring tool could collect data from a sensor(s) using infrared, visible and/or ultraviolet wavelengths. The collected information can be integrated together to be compared to information stored in a database 194. The monitoring tool 125 could, e.g., collect hyperspectral images that are used to characterize the material of, e.g., the earthen material. Hyperspectral sensors could be such as disclosed in Korean Publication KR101806488, incorporated herein by reference. The sensor(s) could generate X-rays or polarized light that is reflected off collected ore and collected by the sensor on the unmanned vehicle.

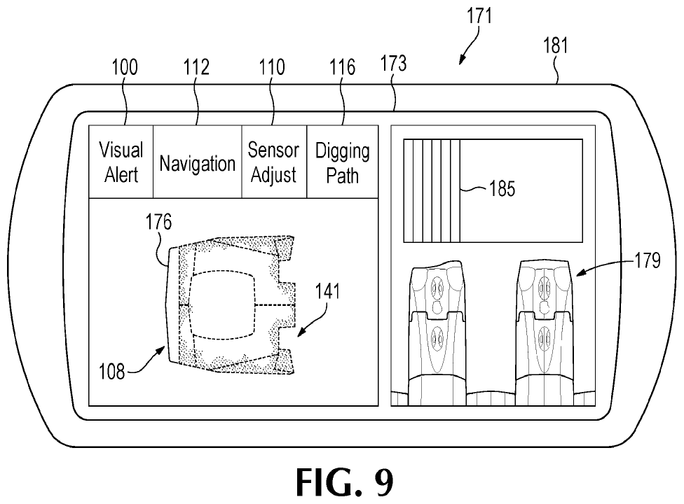

The sensor 131 and/or processor 199 may be configured to generate information on a Human Machine Interface (HMI) 171 (FIG. 9) for use by an equipment operator, manager, auditor, contractor, vendor and/or other person. The HMI 171 may, for example, be a handheld device 128 or other monitor. The handheld device may be, for example, a computer, a phone, a tablet, or other small device that can be held and/or carried by an operator 2. The HMI could be in, e.g., the cab of the earth working equipment, a service vehicle, a station, an office, etc. The handheld device 128 or other HMI could include a processor 199 that could combine data from the monitoring tool 125, cloud database 194, other data sources, other remote device, etc. to provide information and analysis. An operator may physically hold the handheld device 128 as the monitoring tool 125 monitors the product (FIG. 8). The HMI 171 could alternatively be mounted on a stationary or adjustable support. Referring to FIG. 9, the HMI 171 may be a wireless or wired device, may be integrated with a display system in the excavating equipment, and/or may be located in a remote location.

The HMI 171 may include information pertaining to what is being monitored. In the example shown in FIG. 9, the HMI includes a visual alert 100, navigation controls 112 for the unmanned vehicle 136, sensor controls 110, a digging path optimization interface 116, etc. (FIG. 9). The HMI 171 may be configured to provide a graphical display 173 of the current status of the product 176. For example, a display 173 may be configured to display, e.g., a profile of the monitored product 176, and/or image captured by the sensor 131 (e.g. camera). The image may include a live video feed. The display 173 may be configured to display both still images and/or video images. The profile 179, or image may be captured from a vantage point determined relative to the product not primarily dependent of the operator manipulation of the excavating machine controls. The display 173 may also display a graphical representation 185 indicative of, for example, a level of wear. The graphical representation may be or include text and/or a numeric value and/or a condition, e.g. “broken tooth”, and like. In this way an operator, or other worker at or associated with the worksite, may be made aware of a potential problem, or characteristic of the product via the alert 100 and may be able to confirm, or discount the condition, and/or provide a value judgement as to the severity of the condition. In this way, unnecessary downtime may be reduced. In another example, the HMI 171 may be designed to display a history chart 185 so that an operator can determine when an alert happened so that an operator can take the necessary actions if a product is lost. While specific examples are shown in FIG. 9, they are meant only as examples and not to be limiting.

The monitoring tool 125 may include a maneuvering device 129 (e.g., an articulated, controlled arm, driven universal joint, etc.) for maneuvering at least one electronic device or sensor 131. The maneuvering arm 129 may be securely connected to the unmanned vehicle 36 at one end 45 and to the sensor 131 at the opposed end 146. In certain examples, the maneuvering device 129 is mounted, so that it can obtain a better view (e.g., a clear line of sight) to monitor the products. The processor 199 may include instructions to control the orientation of the maneuvering device 129. Maneuvering device 129 could, e.g., be a controlled, articulated arm, swivel or other maneuvering implement.

The monitoring tool 125 and/or separate processor 199 may include instructions to control an electronic device or sensor 131. The sensor 131 is physically coupled with, and/or installed on the unmanned vehicle 136 of the monitoring tool 125 and may be configured to monitor at least one characteristic of an earth working operation, which in one example includes the monitoring of a ground-engaging product. The sensor 131 can optionally work in conjunction with one or more other sensor separate from the unmanned vehicle. A separate sensor can optionally be positioned on the earth working equipment, service vehicle, etc. The sensor 31 on the tethered unmanned vehicle 136 can be a passive or active sensor that collects data.

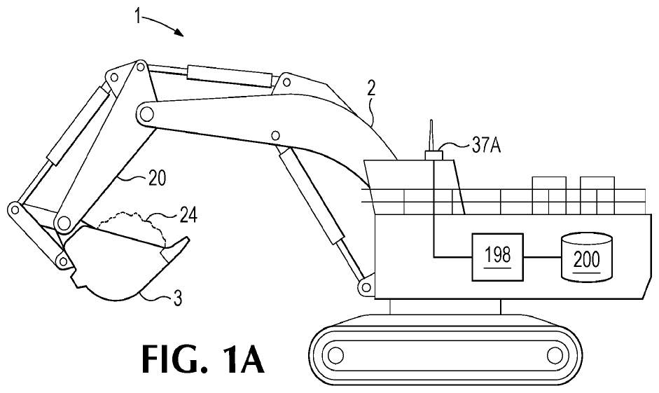

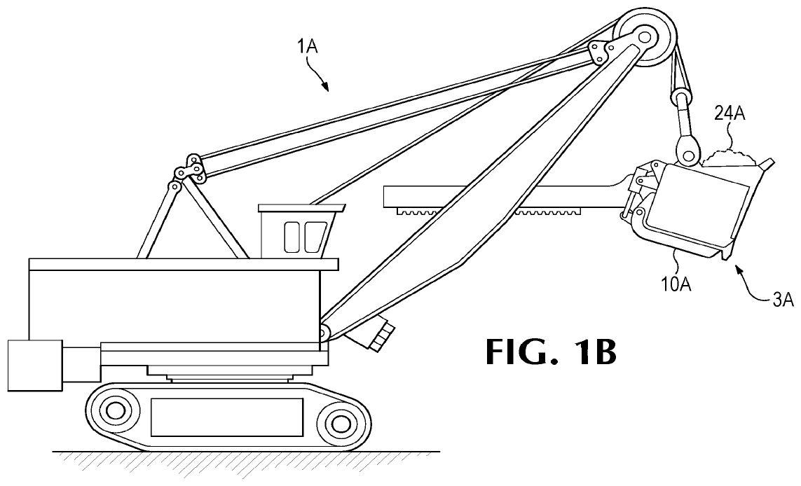

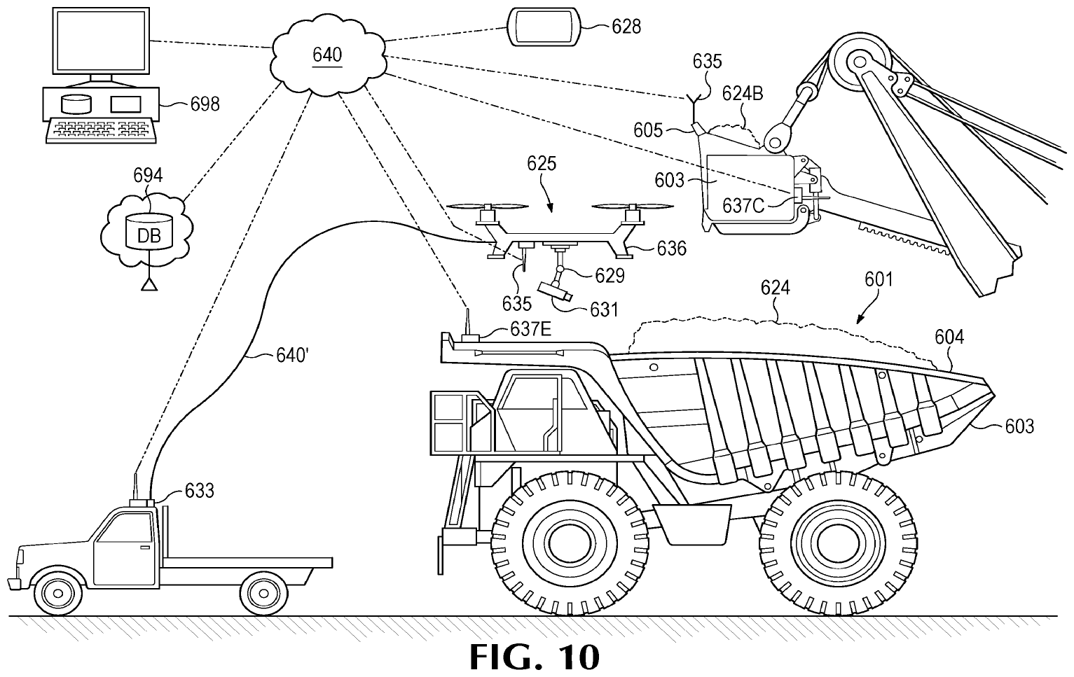

FIG. 10 illustrates another example of a system 639, which in this involves monitoring at least one characteristic of an earth working operation including the loading of a truck tray 603 of a haul truck 601. Similar reference numbers are used in as used in FIG. 1 as the previous figures to refer to the same or similar features, but in FIG. 11, the “600 series” is used (e.g., if a feature with reference number “XX” is used in FIGS. 1A, 1B, and 5-6, the same or similar feature may be shown in FIG. 11 by reference number “6XX”). The system 639 includes a haul truck 601 having a truck tray 603, a communication network 640, and a monitoring tool 625. The truck tray 603 may be empty or carrying a load 624 (shown in phantom). The truck tray 603 may further include runners and other wear parts.

In one example, a monitoring tool 625 can provide data for a real-time assessment of characteristics of an earth working operation. The electronic device 631 may generate a two (2D) or three-dimensional (3D) point cloud representing a load. In one alternative, the monitoring tool 625 may monitor the load 624 within the truck 601 (e.g., on a truck bed 603) without interrupting the operation of the loading truck 601. Monitoring the load 624 of the truck 601 allows the operators of the earth working equipment to know, e.g., when they have reached a full, evenly distributed load. Overloading truck 601 can lead to premature wear and/or damage and underloading can lead to sub-optimal operation. Monitoring tool 625 could, for example, include concurrent monitoring of the excavating equipment 603, the haul truck 601, the earthen material 624, etc.

The monitoring tool and/or system may use programmable logic to determine the amount of earthen material within the earth working equipment based on, e.g., a two or three-dimensional profile of the load 624. The monitoring tool and/or system may also determine an estimated weight of the load 624 within the truck 601 based on volume (determined, e.g., from the profile), the degree of fragmentation of the material (e.g. through excavation or through crushing), and/or the ore concentration. The monitoring tool 625 may also verify the estimated weight of the load 624 by comparing the estimated weight to the stated weight from a load monitoring unit installed on the earth working equipment.

1-17. (canceled)

18. A monitoring tool comprising:
an unmanned vehicle including an electronic device to monitor at least one characteristic pertaining to an earth working operation, and to transmit information pertaining to the at least one characteristic; and
a tether to connect the unmanned vehicle to a home device.

19. The monitoring tool of claim 18, wherein the tether provides power to the unmanned vehicle.

20. The monitoring tool of claim 19, wherein the tether transmits the information pertaining the at least one characteristic to the home device.

21. The monitoring tool of claim 18, wherein the tether transmits the information pertaining the at least one characteristic to the home device.

22. The monitoring tool of claim 18, wherein the at least one characteristic relates to wear and/or damage to an earth working equipment and/or wear parts secured to the equipment.

23. The monitoring tool of claim 18, wherein the at least one characteristic relates to whether wear parts remain secured to an earth working equipment.

24. The monitoring tool of claim 18, wherein the at least one characteristic relates to an amount of earthen material gathered in a cavity of the earth working equipment.

25. The monitoring tool of claim 18, wherein the at least one characteristic relates to a measure of performance by an earth working equipment.

26. The monitoring tool of claim 18, wherein the at least one characteristic relates to a usage by an earth working equipment.

27. The monitoring tool of claim 18, wherein the at least one characteristic relates to a concentration of at least one ore in earthen material associated with the earth working operation.

28. The monitoring tool of claim 18, wherein the unmanned vehicle is an aerial vehicle.

29. The monitoring tool of claim 18, wherein the unmanned vehicle is remotely and/or autonomously operated.

30. The monitoring tool of claim 18, wherein the unmanned vehicle is a ground-based robot.

31. The monitoring tool of claim 18, wherein the at least one characteristic relates to part identification, presence, condition, usage and/or performance of equipment and/or products associated with the earth working equipment.

32. A monitoring tool comprising:
a home device;
an unmanned vehicle including an electronic device to monitor at least one characteristic pertaining to an earth working operation, and to transmit information pertaining to the at least one characteristic; and
a tether connecting the unmanned vehicle to the home device.

33. The monitoring tool of claim 32, wherein the tether provides power to the unmanned vehicle.

34. The monitoring tool of claim 33, wherein the home device includes a power source for powering the unmanned vehicle and/or the electronic device.

35. The monitoring tool of claim 32, wherein the tether transmits the information pertaining the at least one characteristic to the home device.

36. The monitoring tool of claim 35, wherein the home device includes a transmitter, receiver and/or transceiver to send and/or receive data through the tether.

37. The monitoring tool of claim 32, wherein the unmanned vehicle is an aerial vehicle.

38. The monitoring tool of claim 32, wherein the unmanned vehicle is remotely and/or autonomously operated.

39. The monitoring tool of claim 32, wherein the unmanned vehicle is a ground-based robot.

40. A monitoring system comprising:
at least one earth working equipment; and
a monitoring tool including:
a home device;
an unmanned vehicle including an electronic device to monitor at least one characteristic pertaining to an earth working operation, and to transmit information pertaining to the at least one characteristic; and
a tether connecting the unmanned vehicle to the home device.

41. The monitoring system of claim 40, wherein the earth working equipment is a bucket.

42. The monitoring system of claim 40, wherein the earth working equipment is for mineral processing.

43. The monitoring system of claim 40, wherein the earth working equipment is a haul truck.

44. The monitoring system of claim 40, wherein the tether provides power to the unmanned vehicle.

45. The monitoring system of claim 40, wherein the tether transmits the information pertaining the at least one characteristic to the home device.

46. The monitoring tool of claim 40, wherein the unmanned vehicle is an aerial vehicle.

47. The monitoring tool of claim 40, wherein the unmanned vehicle is a ground-based robot.
